(19) United States
(12) Patent Application Publication
(10) Pub. No.: US 2015/0120192 A1
(43) Pub. Date: Apr. 30, 2015

(54) NAVIGATION GUIDANCE INCLUDING PROVISION OF STOPS

(71) Applicants: Aviv Ron, Klachim (IL); Tomer Rider, Naahryia (IL); Yevgeniy Kiveisha, Bney Aish (IL)

(72) Inventors: Aviv Ron, Klachim (IL); Tomer Rider, Naahryia (IL); Yevgeniy Kiveisha, Bney Aish (IL)

(21) Appl. No.: 14/125,305

(22) PCT Filed: Oct. 25, 2013
(86) PCT No.: PCT/US2013/066840

§ 371 Date: Dec. 10, 2013

(51) Int. Cl. G01C 21/36

(52) U.S. Cl. CPC G01C 21/36; G01C 21/3608
USPC 701/539; 701/400

(57) ABSTRACT

Methods, apparatuses and storage medium associated with providing navigation guidance that may include stops, are disclosed. An apparatus, in one embodiment, may include one or more processors; and a navigation application to be operated by the one or more processors to provide navigation guidance to a destination. The navigation application may be configured to provide the navigation guidance including a stop at a location while en route to the destination, in response to receipt of a request for the stop, without specification of where the stop is to take place. Other embodiments may be disclosed or claimed.

### TECHNICAL FIELD

This application relates to the technical field of data processing, more specifically to methods and apparatuses associated with provision of navigation guidance that includes stops.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Advances in integrated circuit, computing, communication and related technologies have led to widespread adoption of navigation applications and systems. Today, travelers may pre-plan a route to a destination using web based navigation applications. Travelers may also receive continuous navigation guidance from on-board or portable navigation guidance systems in vehicles. While en route to a destination, travelers often have needs to make a stop, e.g., a lunch stop, a rest room stop or an emergency stop. Today's navigation applications and systems, beside showing points of interests (POI), recalculating and resuming guidance, generally lack user friendly support for making a scheduled or unscheduled stop.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an arrangement for providing navigation guidance that may include stops;

FIG. 2 illustrates a method for providing navigation guidance that may include stops;

FIG. 3 illustrates an example computing device suitable for use practice the method of FIG. 2, and

FIG. 4 illustrates an example non-transitory computer readable storage medium having instructions configured to cause a computing device or system to practice all or selected aspects of the method of FIG. 2; all arranged in accordance with embodiments of the present disclosure.

### DETAILED DESCRIPTION

Methods, apparatuses and storage medium associated with providing navigation guidance that may include stops are disclosed. An apparatus, in one embodiment, may include one or more processors; and a navigation application to be operated by the one or more processors to provide navigation guidance to a destination. The navigation application may be configured to provide the navigation guidance including a stop at a location while en route to the destination, in response to receipt of a request for the stop, without specification of where the stop is to take place.

As a non-limiting example, the stop may be an unscheduled rest room stop, and the location may be a gas station that allows for relative ease of resumption of the travel to the destination or adds a minimal amount of time to the total travel time. As another non-limiting example, the stop may be an unscheduled emergency stop, and the location may be a road side shoulder that meets certain default and/or user specified safety requirements.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).”

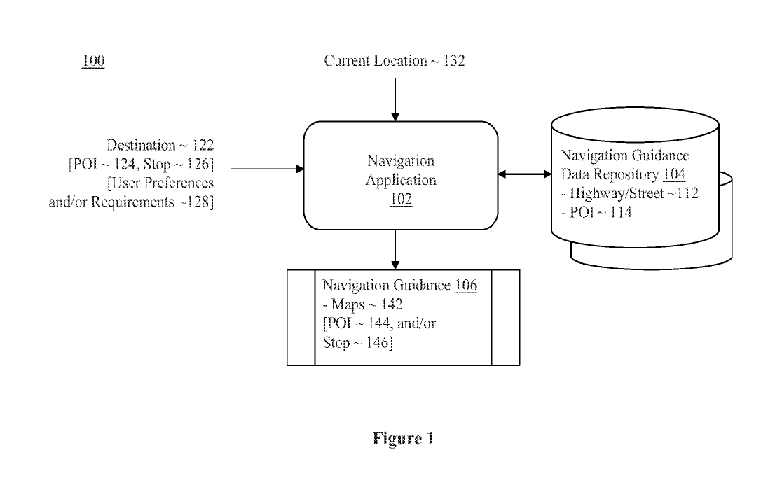

Referring now to FIG. 1, wherein an arrangement for providing navigation guidance that may include stops, in accordance with various embodiments of the present disclosure, is illustrated. As shown, arrangement 100 may include navigation application 102 and navigation guidance data repository 104, operatively coupled with each other. Navigation application 102 may be configured to provide navigation guidance 106 to a destination that may include one or more stops at one or more locations while en route to the destination, in response to one or more requests for the one or more stops, without specification of where the one or more stops are to take place. As described earlier, examples of stops may include, but are not limited to, a break stop or an emergency stop. Navigation application 102 may select the one or more stops at the one or more locations, and provide the navigation guidance 106 that includes the one or more stops at the one or more locations, based at least in part on the navigation guidance data stored in navigation guidance data repository 104, and default and/or user provided preferences and/or requirements, if any.

As shown, navigation guidance data repository 104 may include highway and street data 112, and points of interest (POI) data 114. Highway and street data 112 may include primary data, such as names of the highways and streets, intersections, on-ramps, off-ramps, directions of travel, number of lanes, whether there are right and/or left turn lanes, widths, lengths, speed limits, and so forth. In various embodiments, highway and street data 112 may include secondary data, in particular, safety related data, such as, but not limited to, shoulder widths of the various highway and street segments, prior accidents at the various intersections, street lighting locations or conditions, and so forth.

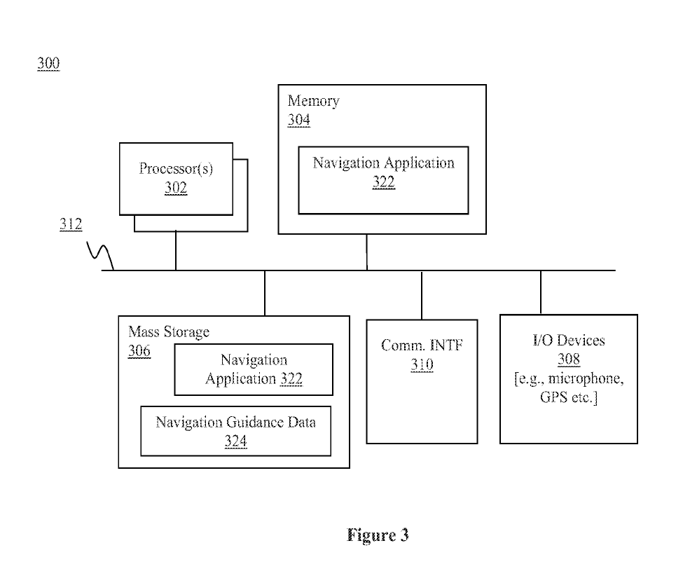

Accordingly, navigation application 102 may generate and provide navigation guidance 106 to destination 122, from current location 132, in response to a request to provide navigation guidance to destination 122, based at least in part on the navigation guidance data in navigation guidance data repository 104. In various embodiments, navigation application 102 may receive specification of destination 122 through one or more input/output devices (e.g., 308 of FIG. 3). The one or more input/output devices, e.g., may be a touchscreen provided with a user interface and a soft keyboard. As another example, the one or more input/output devices may be a display screen provided with a user interface, and a keyboard and/or a cursor control device. As still another example, the one or more input/output devices may be a microphone to facilitate vocal provision of the specification of destination 122. In various embodiments, current location 132 may be similarly provided as destination 122. Alternatively, current location 132 may be received e.g., from a Global Positioning System (GPS) (e.g., 308 of FIG. 3), co-located with navigation application 102.

In various embodiments, the request to provide navigation guidance to destination 122 (hereinafter, the initial request) may further include request for showing POI 124 of one or more particular types along the route, and/or providing for one or more stops 126 of various stop types (without specification of where the stops are to take place). [The square brackets around POI 124 and stops 126 in FIG. 1 denote the request for showing POI 124 and provision for stops 126 being optional.] In various embodiments, POI 124 may include, but are not limited to, a landmark, a rest area, a gas station, a restaurant, a diner, or a coffee shop. One or more stops 126 may include, but are not limited to, a rest stop, a rest room stop, a breakfast stop, a lunch stop, a drink stop, or a dinner stop. In various embodiments, the request (as part of the initial request) to show POI 124 of one or more particular types along the route, and/or provide for one or more stops 126 of various stop types, may be similarly provided to navigation application 102, as destination 122 is provided. In various embodiments, arrangement 100 may include a dedicated (hard or soft) “break/emergency” button for the user to make a “break/emergency” stop.

In various embodiments, user preferences and/or requirements 128 may likewise be provided to navigation application 102, as destination 122, POI 124, and/or stops 126 are provided. [Similarly, the square brackets around user preferences and/or requirements 128 in FIG. 1 denote the specification of user preferences and/or requirements 128 being optional.] Examples of user preferences and/or requirements 128 may include preferences for a particular type of restaurants for breakfast, lunch or dinner stops, maximum amount time being added to the travel time when making a stop, and so forth. User preferences and/or requirements 128 provided may be provided for a specific stop or stops in general.

In response, as described earlier, navigation application 102 may select locations for the one or more stops 146, and provide navigation guidance 106 to destination 122 with one or more maps 142, showing POI 144 and/or locations for the one or more stops 146, as requested, using navigation guidance data in navigation guidance data repository 104, and in accordance with default and/or user preferences and/or requirements 128, if any. For on board or portable embodiments, navigation application 102 may provide navigation guidance 106 to destination 122 continuously through successive refresh of one or more maps 142, as current location 132 gets closer and closer to destination 122.

Further, for on board or portable embodiments, the request to show POI 124 of one or more particular types along the route, and/or provide for one or more stops 126 of various stop types (without specifying the stop locations), may be subsequently made, after the initial request, during provision of the navigation guidance to destination 122. In response, navigation application 102 may regenerate and update the navigation guidance to destination 122, based at least in part on the navigation guidance data in navigation guidance data repository 104, and/or default/user preferences and/or requirements 128, if any. In various embodiments, for subsequent stop requests, a stop 126 may be an emergency stop. Default and/or user preferences and/or requirements 128 may further include, but is not limited to, optimal road shoulder width and/or speed limit for an emergency stop. Accordingly, navigation application 102 may select a location for the emergency stop, e.g., a road side shoulder, and provide for guidance for such an emergency stop, if appropriate. In various embodiments, a subsequent POI or stop request may be similarly provided to navigation application 102, as an initial request, as earlier described.

In various embodiments, in general, navigation application 102 may select a venue or location commensurate with the stop type, and provide for a stop 126 at the venue or location. For example, navigation application 102 may select and provide for a stop at a rest area, a gas station, a restaurant, or a coffee shop if the stop type is rest room stop. On the other hand, navigation application 102 may select and provide for a stop at a restaurant or a coffee shop, depending on whether the stop type is breakfast stop, lunch stop, drink stop or dinner stop. Further, navigation application 102 may select and provide for a stop at a road shoulder, if the stop type is an emergency stop.

In various embodiments, except for emergency stop, navigation application 102 may select and provide for a stop 126 in view of ease of resuming travel to destination 122 or an amount of time added to a travel time to destination 122. For an emergency stop, navigation application 102 may select and provide for the emergency stop at a road shoulder that meets one or more safety requirements, e.g., the width of the road shoulder, the speed limit for the stop location, lighting condition at a location, and so forth. In various embodiments, navigation application 102 may be pre-configured with the safety requirements for emergency stops. In various embodiments, as described earlier, where appropriate, e.g., other than emergency stops, navigation application 102 may select and provide for a stop in view of one more user preferences specified for a specific stop or a stop type. For example, navigation application 102 may select and provide for a stop at an Italian restaurant, if the user has specified a user preference for Italian cuisine for a stop, or for meal stops in general. However, the selection to stop at an Italian restaurant may be subject to ease of resuming travel or amount of travel time added, which too may be user specified. In various embodiments, navigation application 102 may be configured to provide for a user interface for a user to specify the one or more user preferences and/or requirements 128 for each stop type, or for a specific requested stop.

In various embodiments, when selecting a location, and providing for a stop, navigation application 102 may offer the user a choice to select one of a number of stop location candidates. For example, for a rest room stop, navigation application 102 may offer the user a choice to stop at a gas station in 5 minutes, stop at a coffee shop in 15 minutes, and so forth. As another example, for an emergency stop, navigation application 102 may offer the user a choice to stop at the road shoulder now, stop at a rest area in 10 minutes, and so forth. Offering of the choices and receipt of the user selection may be facilitated through various input/output devices, as earlier described for provision of destination 122, request for POI 124 or stops 126, and user preferences and/or requirements 128.

In various embodiments, on selecting a stop for a subsequent request, navigation application 102 may revise and update the previous determined routing.

In various embodiments, navigation application 102 and navigation guidance data repository 104 may be co-located, e.g., part of a computing device or system disposed in a vehicle. In other embodiments, navigation guidance data repository 104 may include a plurality of databases, with at least a subset of the databases, e.g., databases holding secondary data, such as the width of the shoulder for a segment of roadway, number of accidents at an intersection, and so forth, remotely disposed from navigation application 102. For example, data associated with the width of road shoulder for a segment of a roadway may reside with a remote database provided by a transportation or road work department of a local authority. As another example, data associated with accidents at an intersection may reside with a remote database provided by a public safety department of a local authority. For these embodiments, navigation application 102 may access the remotely disposed databases, via one or more wired and/or wireless, local and/or wide area, private and/or public networks, through corresponding networking equipment disposed at the local end hosting navigation application 102, and at the remote ends hosting the remote databases.

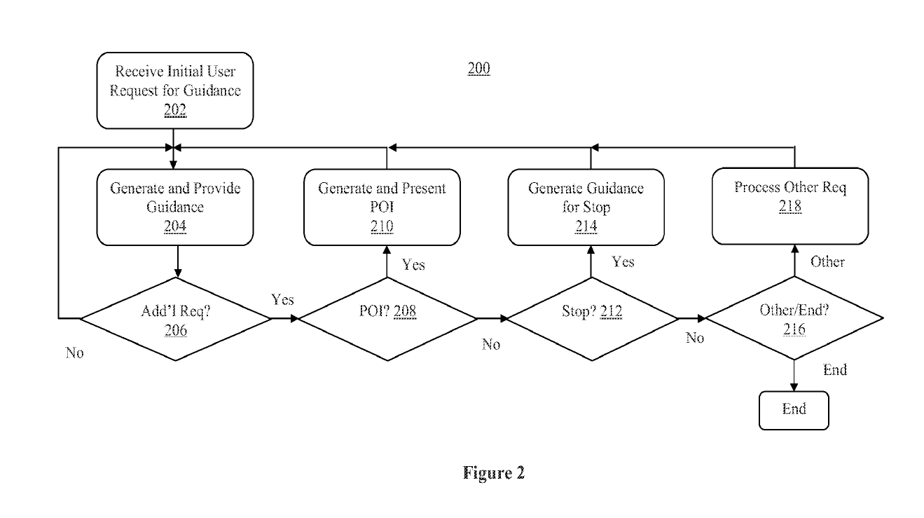

Referring now to FIG. 2, wherein a method for providing navigation guidance that may include stops, in accordance with various embodiments of the present disclosure, is illustrated. As shown, method 200 may include operations performed at block 202-218. The operations may be performed, e.g., by earlier described navigation application 102, which may be implemented in hardware and/or software. Example of a hardware implementation may include an Application Specific Integrated Circuit (ASIC) or a programmable integrated circuit, such as Field Programmable Gate Array, endowed with the logic to perform the described operations. Example of a software implementation may include programming instructions configured to cause an apparatus to perform the described operations, in response to execution of the programming instructions by one or more processors of the apparatus. The programming instructions may be expressed with native instructions of the instruction set architecture (ISA) supported by the one or more processors, or in high level programming instructions with compiler support to compile the high level programming instructions into the supported native instructions.

At block 202, an initial request for navigation guidance to a destination may be received. From block 202, method 200 may proceed to block 204. At block 204, in response to the initial request, navigation guidance to the destination may be generated and began to be provided. For on board or portable embodiments, from block 204, method 200 may proceed to block 206. At block 206, a determination may be made with respect to whether an additional user request has been received, while en route to the destination. If no additional user request has been received, method 200 may return to block 204, and continue therefrom as earlier described. On the other hand, if an additional user request has been received, method 200 may proceed to block 208.

At block 208, a determination may be made with respect to whether the additional user request is associated with showing POI. If the additional user request is associated with showing POI, method 200 may proceed to block 210. At block 210, the applicable POI may be selected and integrated with the navigation guidance being provided. From block 210, method 200 may return to block 204, and continue therefrom as earlier described. On the other hand, if it is determined at block 208 that the additional user request is not for showing POI, method 200 may proceed to block 212.

At block 212, a determination may be made with respect to whether the additional user request is associated with providing for a stop, e.g., a break stop or an emergency stop. If the additional user request is associated with providing for a stop, method 200 may proceed to block 214. At block 214, a location for the stop may be selected, based at least in part on the stop type, and in accordance with default and/or user preferences or requirements, if any, and guidance for the requested stop may be provided, as earlier described. From block 214, method 200 may return to block 204, and continue therefrom as earlier described. On the other hand, if it is determined at block 212 that the additional user request is not for providing for a stop, method 200 may proceed to block 216.

At block 216, a determination may be made with respect to whether the additional user request is associated with ending the navigation guidance or some other user request, other than showing POI or providing for a stop. If the additional user request is not associated with ending the navigation guidance, method 200 may proceed to block 218. At block 218, the user request, other than for showing POI or providing a stop, may be serviced accordingly. From block 218, method 200 may return to block 204, and continue therefrom as earlier described. On the other hand, if it is determined at block 216 that the additional user request is associated with ending the navigation guidance, method 200 may end.

Thus, with arrangement 100 of FIG. 1 and method 200 of FIG. 2, whenever a driver has a need for a stop while en route to a destination, the driver may make a request for the stop (without specifying the location of the stop), by, e.g., selecting/clicking a “break” button of arrangement 100. In response, navigation application 102 may search for all eligible stop locations nearby, calculate estimated time of arrival, including possible detour of the planned route, as earlier described. Where multiple stop locations are eligible, navigation application 102 may select one of the eligible locations in view of default or user requirements, or provide the driver with a list of the eligible locations for selection, as earlier described. On selection of the stop location, either by the system or the user, navigation application 102 may revise or update the previous determined route adding the stop, along with any detour, and continue to provide guidance, as described earlier.

FIG. 3 illustrates an example computing device or system suitable for use to practice the method of FIG. 2, in accordance with various embodiments of the present disclosure. As shown, computing device or system 300 (hereinafter, simply “computer”) includes a processor and memory arrangement having a number of processors or processor cores 302, and system memory 304. For the purpose of this application, including the claims, the terms “processor” and “processor cores” may be considered synonymous, unless the context clearly requires otherwise. Additionally, computer 300 includes mass storage devices 306 (such as diskette, hard drive, compact disc read only memory (CD-ROM) and so forth), input/output (I/O) devices 308 (such as the earlier described microphones and/or GPS components), and communication interfaces 310 (such as, WiFi, Bluetooth, 3G/4G network interface cards, modems and so forth). The elements may be coupled to each other via system bus 312, which represents one or more buses. In the case of multiple buses, the multiple buses may be bridged by one or more bus bridges (not shown).

Each of these elements may be configured to perform its conventional functions known in the art. In particular, processors 302 may be configured to provide an application execution environment. Further, system memory 304 may be employed to store a working copy of the programming instructions configured to implement navigation application 322 and perform all or selected operations of method 200 earlier described with references to FIG. 2. As described earlier, navigation applications 322 may be implemented by assembler instructions supported by processor(s) 302 or high-level languages, such as, e.g., C, that can be compiled into such instructions.

Mass storage 306 may include a persistent copy of the programming instructions of navigation application 322 and locally stored navigation guidance data of navigation guidance data repository 324. The persistent copy of these programming instructions of navigation application 322 and locally stored navigation guidance data of navigation guidance data repository 324 may be placed into mass storage 306 in the factory, or in the field, through, e.g., a distribution medium (not shown), such as a compact disc (CD), or through communication interface 310 (from a distribution server (not shown)). That is, one or more distribution media having an implementation of navigation application 322 may be employed to distribute navigation application 322 to program various computing devices.

Otherwise, the constitution of the depicted elements 302-314 are known, and accordingly will not be further described. In various embodiments, computer 300 may have more or less components, and/or different architectures.

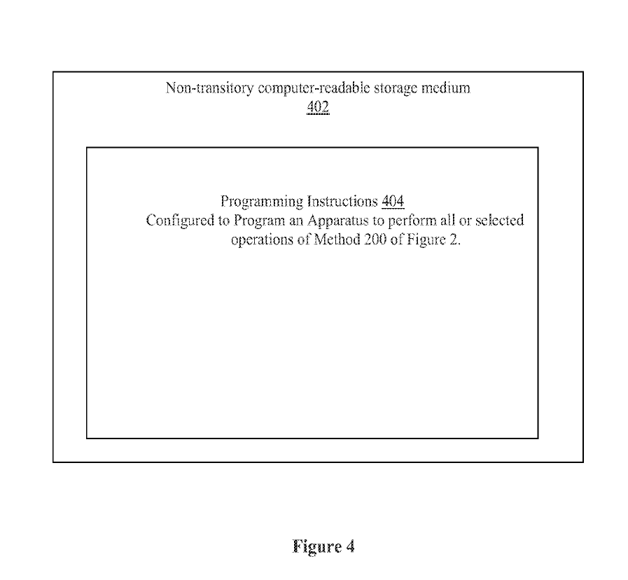

FIG. 4 illustrates an example non-transitory computer readable storage medium having instructions configured to practice all or selected aspects of the method of FIG. 2; in accordance with various embodiments of the present disclosure. As illustrated, non-transitory computer readable storage medium 402 may include a number of programming instructions 404. Programming instructions 404 may be configured to enable a computing device or system, e.g., computer 300, in response to execution of the programming instructions, to perform some or all of the operations of method 200 earlier described with references to FIG. 2. In alternate embodiments, programming instructions 404 may be disposed on multiple non-transitory computer readable storage media 402 instead.

Referring back to FIG. 3, for one embodiment, memory 304 with navigation application 322 may be packaged with one or more processors 302 as a System in Package (SiP). For one embodiment, navigation application 322 may be packaged with one or more processors 302 to form a System on Chip (SoC). For at least one embodiment, the SoC may be utilized in a smartphone, a computing tablet, or a vehicle infotainment device.

The following examples pertain to additional embodiments. Example 1 may be an apparatus for providing navigation guidance. The apparatus may comprise one or more processors, and a navigation application. The navigation application may be configured to be operated by the one or more processors to provide navigation guidance to a destination. Further, the navigation application is to provide the navigation guidance that includes a stop at a location while en route to the destination, in response to receipt of a request for the stop, without specification of where the stop is to take place.

Example 2 may be the apparatus of example 1, wherein the navigation application is to provide an initial route that includes the stop at the location, if the request for the stop is included in an initial request for navigation guidance to the destination.

Example 3 may be the apparatus of example 1 or 2, wherein the navigation application is to revise an initial route to include the stop at the location, if the request for the stop is provided subsequent to an initial request for navigation guidance to the destination.

Example 4 may be the apparatus of example 3, further comprising an audio input device coupled with the navigation guidance application, to facilitate vocal provision of the request for the stop, subsequent to the initial request for navigation guidance to the destination.

Example 5 may be the apparatus of any one of examples 1-4, wherein the navigation application is to support a plurality of stop types, and wherein the navigation application is to select a location or a plurality of location candidates for the stop that is commensurate with the stop type of the requested stop.

Example 6 may be the apparatus of example 5, wherein the plurality of stop types include one or more of a rest stop, a rest room stop, a breakfast stop, a lunch stop, a drink stop, a dinner stop, and an emergency stop.

Example 7 may be the apparatus of example 5, wherein the location comprises a selected one of a rest area, a gas station, a restaurant, a diner, a coffee shop, or a road side shoulder.

Example 8 may be the apparatus of any one of examples 1-7, wherein the stop is an emergency stop, and wherein the navigation application is to select a location or a plurality of location candidates for the emergency stop that meets one or more safety requirements.

Example 9 may be the apparatus of any one of examples 1-8, wherein the navigation application is to support specification of one or more user preferences for the stop or stops in general, and wherein the navigation application is select a location or a plurality of location candidates for the stop in view of the one more user preferences specified.

Example 10 may be the apparatus of any one of examples 1-9, wherein the navigation application is to provide the stop at the location in view of ease of resuming travel to the destination or an amount of time added to a travel time to the destination.

Example 11 may be the apparatus of any one of examples 1-10, further comprises a navigation guidance data repository, and wherein the navigation application provides the navigation guidance that includes the stop, based at least in part on data in the navigation guidance data repository.

Example 12 may be the apparatus of example 11, wherein the one or more processors, the navigation application, and the navigation guidance data repository are co-located, and wherein the navigation application provides the navigation guidance that includes the stop at the location, further based at least in part on data in a remote data repository.

Example 13 may be a method for providing navigation guidance. The method may comprise: receiving, by a computing system, a request for a stop while en route to a destination, without specification of where the stop is to take place; and providing, by the computing system, navigation guidance to the destination that includes the stop at a location, while en route to the destination.

Example 14 may be the method of example 13, wherein receiving comprises receiving the request for a stop in association with an initial request for navigation guidance to the destination; and wherein providing comprises providing an initial route that includes the stop at the location.

Example 15 may be example 13 or 14, wherein receiving comprises receiving the request for a stop subsequent to an initial request for navigation guidance to the destination; and wherein providing comprises revising an initial route to include the stop at the location.

Example 16 may be the method of example 15, wherein receiving comprises receiving the request for the stop vocally, subsequent to the initial request for navigation guidance to the destination.

Example 17 may be the method of any one of examples 13-16, wherein providing comprises selecting a location or a plurality of location candidates commensurate with a stop type of the requested stop.

Example 18 may be the method of example 17, wherein the plurality of stop types include one or more of a rest stop, a rest room stop, a breakfast stop, a lunch stop, a drink stop, a dinner stop, and an emergency stop.

Example 19 may be the method of example 17, wherein the location comprises a selected one of a rest area, a gas station, a restaurant, a diner, a coffee shop, or a road shoulder.

Example 20 may be the method of any one of examples 13-19, wherein the stop is an emergency stop, and wherein provide comprises selecting a location or a plurality of location candidates for the emergency stop that meets one or more safety requirements.

Example 21 may be the method of any one of examples 13-20, wherein receiving further comprises receiving specification of one or more user preferences for the stop or stops in general, and wherein providing comprises selecting a location or a plurality of location candidates for the stop in view of the one more user preferences specified.

Example 22 may be the method of any one of examples 13-21, wherein providing comprises selecting a location or a plurality of location candidates for the stop in view of ease of resuming travel to the destination, or an amount of time added to a travel time to the destination.

Example 23 may be the method of any one of examples 13-22, wherein providing comprises selecting a location or a plurality of location candidates for the stop, based at least in part on data in a navigation guidance data repository.

Example 24 may be the method of example 23, wherein at least a portion of the navigation guidance data repository is remotely disposed from the computing system.

Example 25 may be one or more computer readable storage medium having a plurality of instructions configured to cause a computing system, in response to execution of the instructions, to: receive a request for a stop while en route to a destination, without specification of where the stop is to take place; and provide navigation guidance to the destination that includes the stop at a location, while en route to the destination.

Example 26 may be the storage medium of example 25, wherein receive comprises receive the request for a stop in association with an initial request for navigation guidance to the destination; and wherein provide comprises provide an initial route that includes the stop at the location.

Example 27 may be the storage medium of example 25 or 26, wherein receive comprises receive the request for a stop subsequent to an initial request for navigation guidance to the destination; and wherein provide comprises revision of an initial route to include the stop at the location.

Example 28 may be the storage medium of example 27, wherein receive comprises receive the request for the stop vocally, subsequent to the initial request for navigation guidance to the destination.

Example 29 may be the storage medium of any one of examples 25-28, wherein provide comprises selection of a location or a plurality of location candidates commensurate with a stop type of the requested stop.

Example 30 may be the storage medium of example 29, wherein the plurality of stop types include one or more of a rest stop, a rest room stop, a breakfast stop, a lunch stop, a drink stop, a dinner stop, and an emergency stop.

Example 31 may be the storage medium of example 29, wherein the location comprises a selected one of a rest area, a gas station, a restaurant, a diner, a coffee shop, or a road shoulder.

Example 32 may be the storage medium of any one of examples 25-31, wherein the stop is an emergency stop, and wherein provide comprises selection of a location or a plurality of location candidates for the emergency stop that meets one or more safety requirements.

Example 33 may be the storage medium of any one of examples 25-32, wherein receive further comprises receive specification of one or more user preferences for the stop or stops in general, and wherein provide comprises selection of a location or a plurality of location candidates at the stop in view of the one more user preferences specified.

Example 34 may be the storage medium of any one of examples 25-33, wherein provide comprises selection of a location or a plurality of location candidates for the stop in view of ease of resuming travel to the destination, or an amount of time added to a travel time to the destination.

Example 35 may be the storage medium of any one of examples 25-34, wherein provide comprises selection of a location or a plurality of location candidates for the stop, based at least in part on data in a navigation guidance data repository.

Example 36 may be the storage medium of example 35, wherein at least a portion of the navigation guidance data repository is remotely disposed from the computing system.

Example 37 may be an apparatus for providing navigation guidance. The apparatus may comprise means for providing navigation guidance to a destination, including means for providing navigation guidance for a stop at a location while en route to the destination, in response to receipt of a request for the stop, without specification of where the stop is to take place.

Example 38 may be the apparatus of example 37, further comprising means for storing navigation guidance data; wherein the means for providing navigation guidance that includes the stop comprises means for providing navigation guidance that includes the stop, based at least in part on navigation guidance data in the means for storing navigation guidance data.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present disclosure. This application is intended to cover any adaptations or variations of the embodiments discussed herein. Therefore, it is manifestly intended that the embodiments of the present disclosure be limited only by the claims and the equivalents thereof.

1. An apparatus for providing navigation guidance, comprising:
one or more processors; and
a navigation application to be operated by the one or more processors to provide navigation guidance to a destination, wherein the navigation application is to provide the navigation guidance including a stop at a location while en route to the destination, in response to receipt of a request for the stop, without specification of the location for the stop.

2. The apparatus of claim 1, wherein the navigation application is to provide an initial route that includes the stop at the location, if the request for the stop is included in an initial request for navigation guidance to the destination.

3. The apparatus of claim 1, wherein the navigation application is to revise an initial route to include the stop at the location, if the request for the stop is provided subsequent to an initial request for navigation guidance to the destination.

4. The apparatus of claim 3, further comprising an audio input device coupled with the navigation application, to facilitate vocal provision of the request for the stop, subsequent to the initial request for navigation guidance to the destination.

5. The apparatus of claim 1, wherein the navigation application is to support a plurality of stop types, and wherein the navigation application is to provide the stop at a location commensurate with the stop type of the requested stop.

6. The apparatus of claim 5, wherein the plurality of stop types include one or more of a rest stop, a rest room stop, a breakfast stop, a lunch stop, a drink stop, a dinner stop, and an emergency stop.

7. The apparatus of claim 5, wherein the location comprises a selected one of a rest area, a gas station, a restaurant, a diner, a coffee shop, or a road shoulder.

8. The apparatus of claim 1, wherein the stop is an emergency stop, and wherein the navigation application is to provide the emergency stop at a location that meets one or more safety requirements.

9. The apparatus of claim 1, wherein the navigation application is to support specification of one or more user preferences for the stop or stops in general, and wherein the navigation application is provide the stop in view of the one more user preferences specified.

10. The apparatus of claim 1, wherein the navigation application is to provide the stop at the location in view of ease of resuming travel to the destination or an amount of time added to a travel time to the destination.

11. The apparatus of claim 1, further comprises a navigation guidance data repository, and wherein the navigation application provides the navigation guidance that includes the stop, based at least in part on data in the navigation guidance data repository.

12. The apparatus of claim 11, wherein the one or more processors, the navigation application, and the navigation guidance data repository are co-located, and wherein the navigation application provides the navigation guidance that includes the stop at the location, further based at least in part on data in a remote data repository.

13. One or more non-transitory computer-readable storage medium having a plurality of instructions, in response to execution by a computing system, cause the computer system to:
receive a request for a stop while en route to a destination, without specification of where the stop is to take place; and
provide navigation guidance to the destination that includes the stop at a location, while en route to the destination.

14. The storage medium of claim 13, wherein receive comprises receive the request for a stop in association with an initial request for navigation guidance to the destination; and wherein provide comprises provide an initial route that includes the stop at the location.

15. The storage medium of claim 13, wherein receive comprises receive the request for a stop subsequent to an initial request for navigation guidance to the destination; and wherein provide comprises revise an initial route to include the stop at the location.

16. The storage medium of claim 15, wherein receive comprises receive the request for the stop vocally, subsequent to the initial request for navigation guidance to the destination.

17. The storage medium of claim 13, wherein provide comprises select a location or a plurality of location candidates commensurate with a stop type of the requested stop; wherein the plurality of stop types include one or more of a rest stop, a rest room stop, a breakfast stop, a lunch stop, a drink stop, a dinner stop, and an emergency stop; and wherein the location comprises a selected one of a rest area, a gas station, a restaurant, a diner, a coffee shop, or a road shoulder.

18. The storage medium of claim 13, wherein the stop is an emergency stop, and wherein provide comprises select a location or a plurality of location candidates for the emergency stop that meets one or more safety requirements.

19. The storage medium of claim 13, wherein receive further comprises receive specification of one or more user preferences for the stop or stops in general, and wherein provide comprises select a location or a plurality of location candidates for the stop in view of the one more user preferences specified.

20. The storage medium of claim 13, wherein provide comprises select a location or a plurality of location candidates for the stop in view of ease of resuming travel to the destination, or an amount of time added to a travel time to the destination.

21. The storage medium of claim 13, wherein provide comprises select a location or a plurality of location candidates for the stop, based at least in part on data in a navigation guidance data repository.

22. The storage medium of claim 21, wherein at least a portion of the navigation guidance data repository is remotely disposed from the computing system.

23. (canceled)

24. (canceled)

25. (canceled)

26. A method for providing navigation guidance, comprising:
receiving, by a computing system, a request for a stop while en route to a destination, without specification of where the stop is to take place; and
providing, by the computing system, navigation guidance to the destination that includes the stop at a location, while en route to the destination.

27. The method of claim 26, wherein providing comprises selecting a location or a plurality of location candidates commensurate with a stop type of the requested stop; wherein the plurality of stop types include one or more of a rest stop, a rest room stop, a breakfast stop, a lunch stop, a drink stop, a dinner stop, and an emergency stop; and wherein the location comprises a selected one of a rest area, a gas station, a restaurant, a diner, a coffee shop, or a road shoulder.

28. The method of claim 26, wherein the stop is an emergency stop, and wherein provide comprises selecting a location or a plurality of location candidates for the emergency stop that meets one or more safety requirements.
